(19) United States
(12) Patent Application Publication
(10) Pub. No.: US 2024/0328018 A1
(43) Pub. Date: Oct. 3, 2024

(54) METHOD AND APPARATUS FOR OPERATING AN ELECTROLYSER

(71) Applicant: VESTAS WIND SYSTEMS A/S, Aarhus N (DK)

(72) Inventors: Anders TUXEN, Risskov (DK); Andrew Gordon Syme MCINTOSH, Bagsværd (DK); Lars Rohr THOMSEN, Risskov (DK); Niels Vinther VOIGT, Aarhus N (DK)

(21) Appl. No.: 18/575,156

(22) PCT Filed: Jun. 16, 2022
(86) PCT No.: PCT/DK2022/050129

§ 371 Date: Dec. 28, 2023

(30) Foreign Application Priority Data
Jun. 28, 2021 (DK) PA202170333

(51) Int. Cl. C25B 15/08; C01C 1/04; C25B 1/04; C25B 15/029

(52) U.S. Cl. CPC C25B 15/081; C01C 1/04; C25B 1/04; C25B 15/029

(57) ABSTRACT

A method of operating an electrolyser comprising providing a reactant flow stream to the electrolyser and using the electrolyser to split the reactant into a product flow stream. The magnitude of the power supply to the electrolyser is determined and, if the magnitude of the power supply is less than or equal to a predetermined value, a dilutant gas flow stream is introduced into the reactant flow stream before the electrolyser. The dilutant gas is an inert gas. Also, a system for producing ammonia where the feed stock to the system is provided by the electrolyser.

### TECHNICAL FIELD

The present disclosure relates to a method and apparatus for operating an electrolyser. More particularly, the present disclosure relates to a method and apparatus for operating an electrolyser when power supplied to the electrolyser is below a rated minimum. The present disclosure also relates to a system and method for producing ammonia from a product stream of an electrolyser operated in accordance with the present disclosure.

### BACKGROUND

Hydrogen has been used for many years in industrial processes such as the hydrogenation of fats and oils, reduction of metal ores and production of ammonia amongst others. In recent years there has also been significant interest in hydrogen as a highly efficient energy carrier since it results in no CO₂ emissions when energy is released. Demand for hydrogen is therefore ever increasing.

The most commonly used method of hydrogen production is water electrolysis, a process which requires a tremendous amount of electrical energy. In order to reduce the environmental impact of hydrogen production it is ideal to use only renewable energy sources such as wind or solar power. However, because wind and solar power production is dependent on ever changing environmental conditions, it is difficult in practice to produce hydrogen efficiently from these power sources. During electrolysis, the hydrogen may travel opposite of the intended flow and into the oxygen stream. This process is known as hydrogen cross-over. Particularly when the power available to the electrolyser is low (such as below about 15% nominal power of the electrolyser) the product flow rates may be so low that hydrogen cross-over potentially may result in an explosive gas mixture being formed. This is a safety hazard which clearly cannot be tolerated, so in practice electrolysers are not operated at low loads meaning that potentially useful green energy is not able to be used to produce green hydrogen. It should be observed that the minimum acceptable nominal power (below which hydrogen cross-over becomes unacceptable) varies a lot, and depend for example on type of electrolyser technology, electrode efficiency, separator material, electrolyte choice, flowrates of pumps (if any), what mode and pressure the electrolyser is run under (dry-wet, wet-wet or SOEC).

It is against this background that the present invention has been developed.

### SUMMARY OF THE INVENTION

The present invention provides a method of operating an electrolyser, the method comprising:
providing the electrolyser with a power supply;
providing a reactant flow stream to an inlet of the electrolyser and operating the electrolyser to split the reactant into one or more product flow streams;
determining the magnitude of the power supply; and
introducing a dilutant gas flow stream into the reactant flow stream before the electrolyser if the magnitude of the power supply is less than or equal to a predetermined value, wherein the dilutant gas comprises an inert gas.

The method of the present invention is advantageous as the addition of inert gas to the reactant flow stream lowers the partial pressure of the gas inside the electrolyser and flushes the system so that the likelihood of cross-over of gas from one side of the electrolyser to the other is reduced.

Optionally the inert gas comprises nitrogen which is an abundant and inexpensive gas.

The reactant flow stream may optionally be provided to first and second inlets of the electrolyser, wherein the first inlet is in fluidic communication with a first side of the electrolyser, and the second inlet is in fluidic communication with a second side of the electrolyser, such that the first inlet receives a first reactant flow stream and the second inlet receives a second reactant flow stream; and
introducing the dilutant gas flow stream into the first reactant flow stream before of the first inlet.

A second gas flow stream may be introduced into the second reactant flow stream before the second inlet, wherein the second gas is different to the dilutant gas. The second gas may optionally be oxygen or air, or an inert gas such as nitrogen. It is beneficial to introduce a second gas flow stream into the second side of the electrolyser as it helps to dilute any cross-over gas that may have entered the second side of the electrolyser from the first side of the electrolyser. Dilution of any cross-over gas present in the second side of the electrolyser is beneficial as the effects/consequences of the presence of the cross-over gas in the second side of the electrolyser can be limited or even eliminated.

In one example, the second gas is supplied from a product flow stream which is readily available for use as a second gas flow stream.

Optionally the reactant flow stream comprises water and the dilutant gas comprises nitrogen. This is beneficial when the electrolyser is used to produce hydrogen as a feed stock for an ammonia production process.

The reactant flow stream may optionally comprise water, the dilutant gas comprises nitrogen and the second gas comprises oxygen, wherein the first side of the electrolyser comprises a hydrogen production side, and the second side of the electrolyser comprises an oxygen production side.

A first product flow stream may comprise a mixture of hydrogen and nitrogen when the magnitude of the power supply is less than or equal to the predetermined value.

In one example the method comprises shutting down the electrolyser if the magnitude of the power supply is less than or equal to a second predetermined value, wherein the second predetermined value is less than the predetermined value.

Optionally the flow rate of the dilutant gas is determined in dependence on the magnitude of the power supply such that:
the dilutant gas is introduced at a first flow rate when the power supply is less than the predetermined value; and
the dilutant gas is introduced at a second flow rate when the power supply is equal to the second predetermined value, wherein the second flow rate is greater than the first flow rate.

The molecular ratio of hydrogen to nitrogen in the first product flow stream may be determined, and optionally the electrolyser may be shut down if the molecular ratio of hydrogen to nitrogen in the first product flow stream is less than or equal to three.

The current supplied to the electrolyser may be used to estimate the amount of hydrogen produced by the electrolyser.

In another aspect, the present invention provides a method of providing feed stock to an ammonia production process, the method comprising:
operating an electrolyser configured as described above, wherein the electrolyser produces a first product flow stream comprising a mixture of hydrogen and nitrogen when the magnitude of the power supply is less than the predetermined value; and
providing the first product flow stream as a feed stock to the ammonia production process.

Optionally the molecular ratio of hydrogen to nitrogen in the first product flow stream is greater than or equal to three.

In a further aspect, the present invention provides a system for producing ammonia, the system comprising:
an electrolyser configured to split water into a hydrogen product stream and an oxygen product stream in use, wherein the electrolyser comprises a first inlet and a first outlet on a hydrogen side of the electrolyser, and a second inlet and a second outlet on an oxygen side of the electrolyser;
a first water supply pipe connected to the first inlet and a second water supply pipe connected to the second inlet;
a nitrogen supply pipe connected to the first water supply pipe;
a nitrogen control valve for controlling a flow of nitrogen from the nitrogen supply pipe into the first water supply pipe;
a first product outlet pipe connected to the first outlet of the electrolyser, and a second product outlet pipe connected to the second outlet of the electrolyser;
an ammonia production facility comprising a feed stock inlet, wherein the first product outlet pipe is configured to supply the hydrogen product stream to the feed stock inlet; and
a nitrogen supply apparatus comprising a nitrogen outlet pipe, wherein the nitrogen outlet pipe is configured to supply nitrogen to the nitrogen supply pipe.

Optionally the system as comprises a second nitrogen supply pipe, wherein the second nitrogen supply pipe is configured to supply nitrogen from the nitrogen supply apparatus to the to the feed stock inlet.

The system may optionally comprise: an oxygen supply pipe connected to the to the second water supply pipe; an oxygen control valve for controlling a flow of oxygen from the oxygen supply pipe into the second water supply pipe; and an oxygen supply apparatus comprising an oxygen outlet pipe, wherein the oxygen outlet pipe is configured to supply oxygen to the oxygen supply pipe.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described, by way of example only, with reference to the accompanying drawings, in which:

FIG. 1 shows a schematic drawing of an electrolyser arranged in accordance with the present invention;

FIG. 2 shows a schematic drawing of an efficiency curve for an electrolyser;

FIG. 3 shows a schematic drawing of the electrolyser of FIG. 1 when arranged to supply an ammonia production process; and

FIG. 4 shows a schematic drawing of the electrolyser of FIG. 1 in an alternative arrangement to that shown in FIG. 3.

### DETAILED DESCRIPTION

The following detailed description refers to the accompanying drawings that show, by way of illustration, specific details and embodiments in which the invention may be practiced. These embodiments are described in sufficient detail to enable those of ordinary skill in the art to practice the invention. Other embodiments may be utilised, and structural changes may be made without departing from the scope of the invention as defined in the appended claims.

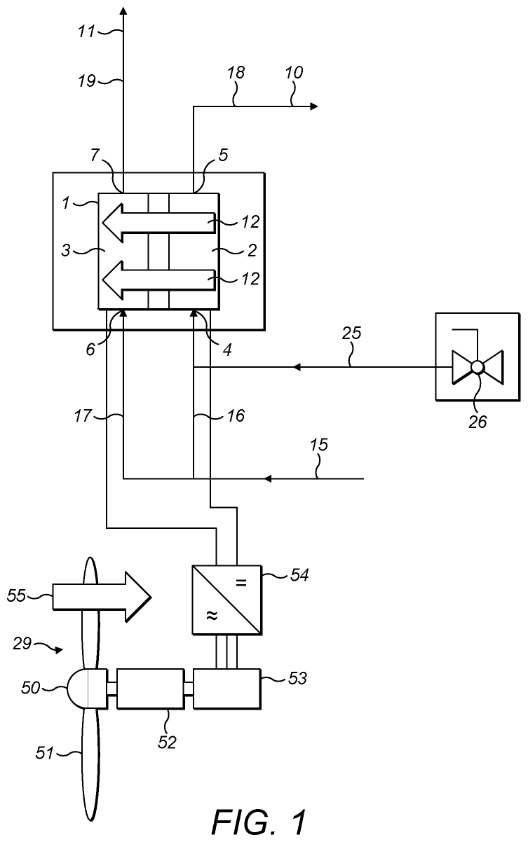

FIG. 1 shows a schematic drawing of an electrolyser 1. The electrolyser 1 comprises a first side 2 and a second side 3. The first side 2 comprises a first inlet 4 for receiving a flow of reactant into the electrolyser 1, and a first outlet 5 for allowing removal of a first product flow stream 10 from the electrolyser 1. Similarly, the second side 3 of the electrolyser 1 comprises a second inlet 6 for receiving a flow of reactant into the electrolyser 1, and a second outlet 7 for allowing removal of a second product flow stream 11 from the electrolyser 1.

If the reactant supplied to the electrolyser 1 via the first and second inlets 4, 6 is water, the first side 2 of the electrolyser 1 may be referred to as the hydrogen side 2, and the second side 3 may be referred to as the oxygen side 3. In the examples that follow the reactant stream is water. However, it will be understood by those skilled in the art that electrolysers may be used to split other water-based reactants in order to produce hydrogen.

The first inlet 4 of the electrolyser 1 is supplied with water from a reactant flow stream 15 via a first water pipe 16, and the second inlet 6 of the electrolyser 1 is supplied with water from the reactant flow stream 15 via a second water pipe 17. The first product flow stream 10 is carried away from the first outlet 5 of the electrolyser 1 by a first product outlet pipe 18, and second product flow stream 11 is carried away from the second outlet 7 of the electrolyser 1 by a second product outlet pipe 19.

When electrical current is applied across the electrolyser 1, and water is supplied as the reactant flow stream 15, the first (or hydrogen) side 2 produces hydrogen as the first product flow stream 10, and the second (or oxygen) side 3 produces oxygen as the second product flow stream 11.

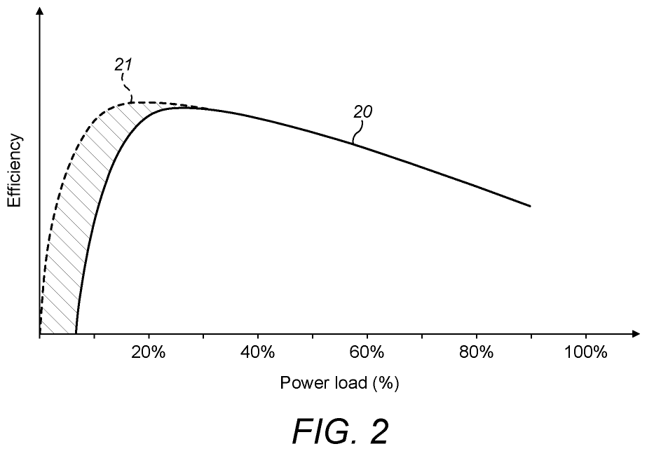

FIG. 2 shows a schematic drawing of an efficiency curve of an electrolyser such as the electrolyser 1 shown in FIG. 1 and described above. The solid line 20 represents the efficiency of the electrolyser 1 as a function of percentage nominal load of the electrolyser. As can be seen, the efficiency of the electrolyser 1 is at a maximum at about 25% load from where it gradually drops-off as power load increases. The efficiency of the electrolyser 1 rapidly drops-off as the power load decreases from around 25% to around 15% which is the minimum possible power load before hydrogen crossover begins to occur. As discussed above, and as illustrated by arrows 12 in FIG. 1, during hydrogen crossover hydrogen travels into the oxygen stream thereby potentially resulting in an explosive gas mixture.

Returning now to FIG. 1, a nitrogen supply pipe 25 is connected to the first water pipe 16. A flow control valve 26 is positioned in the nitrogen supply pipe 25 for controlling flow of nitrogen from a nitrogen supply source (not shown in FIG. 1). Nitrogen may alternatively be supplied directly to the first side of the electrolyser 2 via a separate supply pipe and not into the first water pipe 16.

The electrolyser 1 is connected to a fluctuating or transient power supply 29. In FIG. 1 the fluctuating power supply 29 is schematically represented as a wind turbine 50 which comprises a rotor 51 which is configured to drive a generator 53 optionally via a gearbox 52. Electrical power generated by the generator 53 is converted from and AC power supply to a DC power supply by a rectifier 54. DC current is supplied to the electrolyser 1 directly from the rectifier 54.

It will be understood that the fluctuating power supply 29 may be provided to the electrolyser 1 by any power supply apparatus which typically produces a variable output which is dependent on some environmental condition such as wind power, solar power or wave power. It will also be understood that the power supply to the electrolyser may be provided from a plurality of such devices either directly or through a local or national grid. In addition, a number of power sources may be used to supply the electrolyser 1 and it is not necessary that only one form of renewable energy is employed. For example, wind power may be used together with solar power.

When operating the electrolyser 1, if the available power should fall below 15% of the nominal load of the electrolyser 1 the flow control valve 26 is opened to allow a flow of nitrogen to enter the first water pipe 16 thereby supplying both water and nitrogen to the first (hydrogen) side 2 of the electrolyser. The nitrogen dilutes the hydrogen in the first side 2 of the electrolyser thereby helping to prevent hydrogen crossover to the second (oxygen) side 3 of the electrolyser 1 by reducing the partial pressure of the hydrogen on the first side 2 and by flushing out the reaction products from the first side 2 of the electrolyser 1. Because nitrogen is a relatively inert gas, the nitrogen does not react with the hydrogen under the conditions in the first side 2 of the electrolyser 1 and, as a result, the first product flow stream 10 from the electrolyser 1 in these operation conditions comprises hydrogen and nitrogen.

Referring once again to FIG. 2, the dotted line 21 indicates the efficiency of the electrolyser 1 when the power load is below about 15% and the reactant flow stream delivered to the first side 2 of the electrolyser 1 includes added nitrogen gas. As can be seen, the addition of the nitrogen to the reactant flow stream on the first side 2 of the electrolyser 1 extends operation of the electrolyser 1 below 15% power load resulting in the ability to continue to operate the electrolyser 1 despite low power availability.

Operation of the electrolyser 1 may be manually or automatically controlled by determining the magnitude of the power supply and introducing the nitrogen flow stream into the first water supply pipe 16 before the first inlet 4 on the first side 2 of the electrolyser 1 if the magnitude of the power supply is less than or equal to a predetermined value. For example, the predetermined value may be 15% of nominal load of the electrolyser 1.

The minimum power at which the electrolyser 1 may be safely operated without the addition of nitrogen to the reactant flow stream to the first side 2 may vary according to operational conditions such as temperature, water quality and condition/age/run-time of the electrolyser and its components. For example, an electrolyser which is new, or newly reconditioned, may be capable of operation at 10% of nominal load without addition of nitrogen to the reactant flow stream, whilst and older electrolyser with more run-time hours may only be able to operate at 20% of nominal load without addition of nitrogen to the reactant flow stream. One factor in the minimum possible load (with no nitrogen addition) may be the condition of a membrane separating the first (hydrogen) side 2 from the second (oxygen) side 3 of the electrolyser 1. Thus, the predetermined value may change with operational condition of the electrolyser and control of the operation of the electrolyser 1 may include determination of the predetermined value in dependence on one or more of the temperature, water quality, age/run-time of the electrolyser or any other relevant condition as will be known to a person skilled in the art.

Control of the electrolyser 1 may also comprise determination of a second predetermined value for the magnitude of the power supply, where the second predetermined value is lower than the predetermined value, whereby the electrolyser 1 is shut off if the magnitude of the power supply is less than or equal to the second predetermined value. For example, the second predetermined value may be in the range 2% to 5% of the nominal load of the electrolyser 1 depending on the type of electrolyser, the condition of the electrolyser and other operational conditions such as temperature and water quality.

In addition to the above, control of the electrolyser 1 may comprise determination of the flow rate of the nitrogen in dependence on the magnitude of the power supply. For example, the nitrogen may be introduced at a first flow rate when the power supply is less than or equal to the predetermined value, and subsequently introduced at a second flow rate when the power supply is greater than or equal to the second predetermined value. Where, the second flow rate is greater than the first flow rate. In this way, the relative dilution of the hydrogen on the first side 2 of the electrolyser 1 may be increased as the power supply decreases. Similarly, the relative dilution of the hydrogen on the first side 2 of the electrolyser 1 may be decreased as the power supply increases. The flow rate of the nitrogen may be controlled according to a predetermined profile in which particular power supply magnitudes correspond to particular nitrogen flow rates. The profile may be continuous (linear or curved for example), or non-continuous where the flow rate of the nitrogen is “step changed” in dependence on predetermined step changes in power supply.

In a further option, control of the electrolyser 1 may also comprise determination of the molecular ratio of hydrogen to nitrogen in the first product flow stream 10, and shutting down the electrolyser 1 if the molecular ratio of hydrogen to nitrogen in the first product flow stream 10 is less than or equal to three. This value is chosen to suit the requirements of a feed stock to an ammonia production process. If the first product flow stream 10 is not destined for ammonia production, the molecular ratio at which the electrolyser 1 is shut off may be selected according to any suitable criteria.

In a still further option, control of the electrolyser 1 may also comprise using the current supplied to the electrolyser 1 to estimate the amount of hydrogen produced by the electrolyser 1. A relatively simple, near proportional, relationship exists between the power consumption of the electrolyser 1 and the hydrogen production such that power consumption may be used as a measure for hydrogen production. The estimated hydrogen production may then be used to determine the molecular ratio of hydrogen to nitrogen in the first product flow stream 10 based also on the flow rate of the nitrogen.

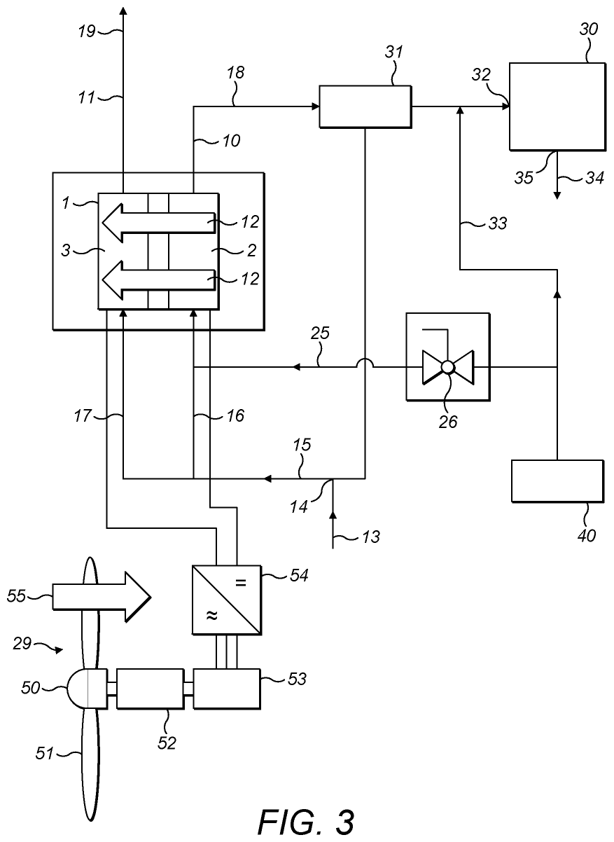

FIG. 3 shows a schematic drawing of the electrolyser 1 when arranged to supply an ammonia production facility 30. In this arrangement the first product flow stream 10 is passed through a separator 31 to remove residual water from the first product flow stream 10. The water is then re-circulated back to the reactant flow stream 15 for re-supply to the inlets 4, 6 of the electrolyser 1. An additional water supply 13 may be supplied to the reactant flow stream 15 at inlet 14.

The first product flow stream 10 is then supplied to the feed stock inlet 32 of the ammonia production facility 30. In cases where the first product flow stream 10 has a molecular ratio of hydrogen to nitrogen of less than three, an additional supply of nitrogen 33 may be added to the first product flow stream 10 in order to bring the molecular ratio of hydrogen to nitrogen to the level required by the ammonia production process. In cases where the first product flow stream 10 has a molecular ratio of hydrogen to nitrogen of less than three, an additional supply of hydrogen may be added to the first product flow stream 10 or (part of the) nitrogen may be removed from the first product stream 10, for example by distillation. An ammonia product flow stream 34 exits the ammonia production facility 30 at an outlet 35.

In the arrangement of FIG. 3, the nitrogen supply for addition to the feed stack 15 of the electrolyser 1, and addition to the feed stock of the ammonia production facility 30, is supplied by an air separation unit (ASU) 40 which is located on site together with the electrolyser 1 and ammonia production facility 30. The ASU may be supplied with power form the local (fluctuation or transient) power supply 29.

In an alternative arrangement to the one shown in FIG. 3, the nitrogen supply for addition to the feed stack 15 of the electrolyser 1 and/or addition to the feed stock of the ammonia production facility 30, may be supplied from gas tanks.

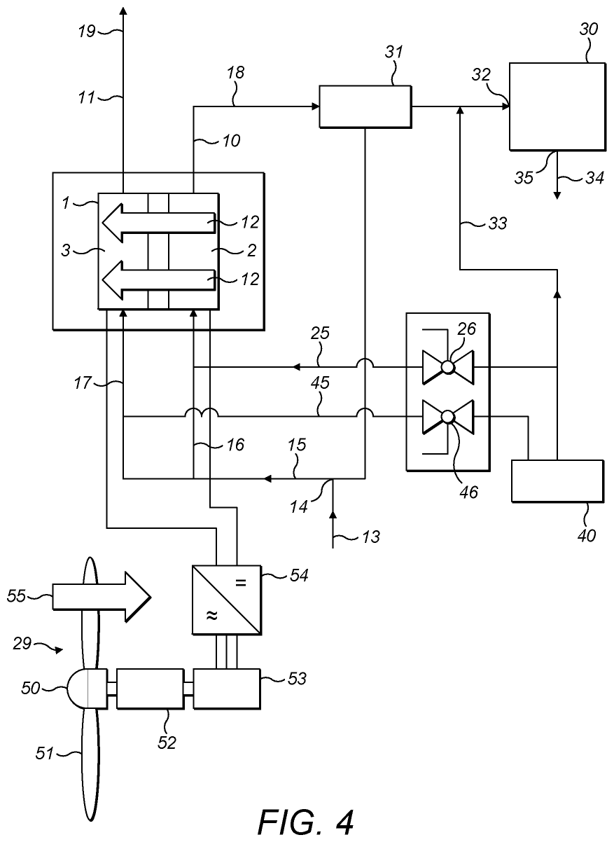

FIG. 4 shows a schematic drawing of the electrolyser 1 in an alternative arrangement to that shown in FIG. 3. The arrangement of FIG. 4 is similar in all respects to the arrangement of FIG. 3 and like numerals have been used to represent like components. In the arrangement of FIG. 4, an oxygen supply pipe 45 is attached to the second water supply pipe 17 before the second inlet 6 of the electrolyser 1. An oxygen flow control valve 46 is positioned in the oxygen supply pipe 25 for controlling flow of oxygen from an oxygen supply source such as the ASU 40. Alternatively, oxygen may be supplied to the oxygen supply pipe from a gas tank.

Oxygen gas may be added to the reactant flow stream 15 supplied to the second inlet 6 of the electrolyser 1 by opening the valve 46 to allow oxygen to be added to the second water supply pipe 17 before the second inlet 6. Addition of oxygen to the second side 3 of the electrolyser 1 at the same time as adding nitrogen to the first side 2 of the electrolyser 1 helps to reduce the risk related to hydrogen crossover by lowering the concentration of hydrogen on the second (oxygen) side 3 of the electrolyser 1.

Control of the addition of oxygen to the second side 3 of the electrolyser 1 may be effected in the same way as described above in respect of the control of the addition of nitrogen to the first side 2 of the electrolyser 1 and the same factors may be taken into consideration when determining when to add oxygen, when to stop adding oxygen, and how much oxygen to add at any given time or operational condition. It will be understood that the flow rates of oxygen and the predetermined values of power supply may be the same as, or different from, the rates and values determined for the control of nitrogen addition to the first side 2.

In a further alternative example (not shown), oxygen may be supplied to the inlet of the second side 3 of the electrolyser 1 from the second product flow stream 11. This may be in addition to, or instead of, oxygen supply via the oxygen supply pipe 45.

The control protocols described above may be automatically carried out by a system of controllers and actuators (not shown) which are controlled by a central control unit such as a computer.

In all of the examples described above there may be more than one electrolyser used to supply feed stock to the ammonia production facility 30. This may be to increase the feed stock supply available and/or to provide redundancy.

It will be understood that for the purposes of the description nitrogen is treated as, and assumed to be, an inert gas. Nitrogen is not the only inert gas which may be added to the first side 2 of the electrolyser 1 in order to extend the operational envelope of the electrolyser (FIG. 2), and other inert gases such as carbon dioxide, neon, argon (or any other inert gas) may be used instead of, or in addition to, nitrogen. Using nitrogen as the diluting gas for the first side 2 of the electrolyser 1 is preferable when the first product flow stream 10 is to be used for supply to the feed stock of an ammonia production process. However, other inert gases may be more suitable in other circumstances. For example, carbon dioxide may be more a more suitable dilutant gas in hydrogen production plants where carbon dioxide produced as a result of the hydrogen production process is captured and stored in a carbon capture facility (so called blue hydrogen).

1. A method of operating an electrolyser, the method comprising:
providing the electrolyser with a power supply;
providing a reactant flow stream to an inlet of the electrolyser and operating the electrolyser to split the reactant into one or more product flow streams;
determining the magnitude of the power supply; and
introducing a dilutant gas flow stream into the reactant flow stream before the electrolyser if the magnitude of the power supply is less than or equal to a predetermined value, wherein the dilutant gas comprises an inert gas.

2. The method as claimed in claim 1, wherein the inert gas comprises nitrogen.

3. The method as claimed in claim 1, comprising:
providing the reactant flow stream to first and second inlets of the electrolyser, wherein the first inlet is in fluidic communication with a first side of the electrolyser, and the second inlet is in fluidic communication with a second side of the electrolyser, such that the first inlet receives a first reactant flow stream and the second inlet receives a second reactant flow stream; and
introducing the dilutant gas flow stream into the first reactant flow stream before of the first inlet.

4. The method as claimed in claim 3, comprising introducing a second gas flow stream into the second reactant flow stream before the second inlet, wherein the second gas is different to the dilutant gas.

5. The method as claimed in claim 4, wherein the second gas is supplied from a product flow stream.

6. The method as claimed in claim 1, wherein the reactant flow stream comprises water and the dilutant gas comprises nitrogen.

7. The method as claimed in claim 4 or 5, wherein the reactant flow stream comprises water, the dilutant gas comprises nitrogen and the second gas comprises oxygen wherein the first side of the electrolyser comprises a hydrogen production side, and the second side of the electrolyser comprises an oxygen production side.

8. The method as claimed in claim 6 or 7, wherein a first product flow stream comprises a mixture of hydrogen and nitrogen when the magnitude of the power supply is less than or equal to the predetermined value.

9. The method as claimed in claim 8, comprising shutting down the electrolyser if the magnitude of the power supply is less than or equal to a second predetermined value, wherein the second predetermined value is less than the predetermined value.

10. The method as claimed in claim 9, wherein the flow rate of the dilutant gas is determined in dependence on the magnitude of the power supply such that:
the dilutant gas is introduced at a first flow rate when the power supply is less than the predetermined value; and
the dilutant gas is introduced at a second flow rate when the power supply is equal to the second predetermined value, wherein the second flow rate is greater than the first flow rate.

11. The method as claimed in claim 9, comprising determining the molecular ratio of hydrogen to nitrogen in the first product flow stream, and shutting down the electrolyser if the molecular ratio of hydrogen to nitrogen in the first product flow stream is less than or equal to three.

12. The method as claimed in claim 1, comprising using the current supplied to the electrolyser to estimate the amount of hydrogen produced by the electrolyser.

13. A method of providing feed stock to an ammonia production process, the method comprising:
operating an electrolyser to produce a first product flow stream comprising a mixture of hydrogen and nitrogen when the magnitude of the power supply is less than the predetermined value, wherein operating the electrolyser, comprises:
providing the electrolyser with a power supply;
providing a reactant flow stream to an inlet of the electrolyser and operating the electrolyser to split the reactant into one or more product flow streams, wherein the reactant flow stream comprises water and the dilutant gas comprises nitrogen;
determining the magnitude of the power supply; and
introducing a dilutant gas flow stream into the reactant flow stream before the electrolyser if the magnitude of the power supply is less than or equal to a predetermined value, wherein the dilutant gas comprises an inert gas; and
providing the first product flow stream as a feed stock to the ammonia production process.

14. The method as claimed in claim 13, wherein the molecular ratio of hydrogen to nitrogen in the first product flow stream is greater than or equal to three.

15. A system for producing ammonia, the system comprising:
an electrolyser configured to split water into a hydrogen product stream and an oxygen product stream in use, wherein the electrolyser comprises a first inlet and a first outlet on a hydrogen side of the electrolyser, and a second inlet and a second outlet on an oxygen side of the electrolyser;
a first water supply pipe connected to the first inlet and a second water supply pipe connected to the second inlet;
a nitrogen supply pipe connected to the first water supply pipe;
a nitrogen control valve for controlling a flow of nitrogen from the nitrogen supply pipe into the first water supply pipe;
a first product outlet pipe connected to the first outlet of the electrolyser, and a second product outlet pipe connected to the second outlet of the electrolyser;
an ammonia production facility comprising a feed stock inlet, wherein the first product outlet pipe is configured to supply the hydrogen product stream to the feed stock inlet; and
a nitrogen supply apparatus comprising a nitrogen outlet pipe, wherein the nitrogen outlet pipe is configured to supply nitrogen to the nitrogen supply pipe.

16. The system as claimed in claim 15, comprising:
a second nitrogen supply pipe, wherein the second nitrogen supply pipe is configured to supply nitrogen from the nitrogen supply apparatus to the to the feed stock inlet.

17. The system as claimed in claim 15, comprising:
an oxygen supply pipe connected to the to the second water supply pipe;
an oxygen control valve for controlling a flow of oxygen from the oxygen supply pipe into the second water supply pipe; and
an oxygen supply apparatus comprising an oxygen outlet pipe, wherein the oxygen outlet pipe is configured to supply oxygen to the oxygen supply pipe.
